(19) United States
(12) Patent Application Publication
(10) Pub. No.: US 2012/0327393 A1
(43) Pub. Date: Dec. 27, 2012

(54) TEMPERATURE MEASURING APPARATUS, SUBSTRATE PROCESSING APPARATUS AND TEMPERATURE MEASURING METHOD

(75) Inventors: Tatsuo MATSUDO, Nirasaki City (JP); Kenji NAGAI, Kurokawa-gun (JP)

(73) Assignee: TOKYO ELECTRON LIMITED, Tokyo (JP)

(21) Appl. No.: 13/529,368

(22) Filed: Jun. 21, 2012

Related U.S. Application Data
(60) Provisional application No. 61/523,888, filed on Aug. 16, 2011.

(30) Foreign Application Priority Data
Jun. 24, 2011 (JP) 2011-140890

(51) Int. Cl. G01J 5/48

(52) U.S. Cl. 356/43

(57) ABSTRACT

The temperature measuring apparatus includes a data input portion, a peak interval calculation portion, an optical path length calculation portion, and a temperature calculation portion. The data input portion inputs a spectrum of interference light that is obtained when measuring light is irradiated onto a surface of the object and the measuring light reflected from the surface and the measuring light reflected from a rear surface interfere with each other. The peak interval calculation portion calculates a peak interval of the input spectrum. The optical path length calculation portion calculates an optical path length based on the peak interval. The temperature calculation portion calculates the temperature of the object based on the optical path length.

### CROSS-REFERENCE TO RELATED PATENT APPLICATIONS

This application claims the benefit of Japanese Patent Application No. 2011-140890, filed on Jun. 24, 2011, in the Japan Patent Office and U.S. patent Application Ser. No. 61/523,888 filed on Aug. 16, 2011, in the United States Patent and Trademark Office, the disclosures of which are incorporated herein in its entireties by reference.

### BACKGROUND OF THE INVENTION

1. Field of the Invention

The present invention relates to a temperature measuring apparatus, a substrate processing apparatus, and a temperature measuring method.

2. Description of the Related Art

Patent Document 1 discloses a kind of temperature measuring system. The temperature measuring system disclosed in Patent Document 1 includes a light source, a splitter, a mirror, a driving unit, and a light receiving unit. Light emitted from the light source is split into measuring light and reference light by the splitter. The measuring light is reflected respectively by opposite end surfaces of an object, and then reaches the light receiving unit via the splitter. The mirror is moved by the driving unit, and when a distance from the splitter to the mirror becomes the same as a distance from the splitter to an end surface of the object, interference peaks occur. A distance between two interference peaks becomes a length of an optical path between the opposite end surfaces of the object. A temperature may be measured from the obtained optical path length.

However, in order to measure the temperature of the object from the optical path length, a thickness measuring operation of high accuracy is necessary. Thus, a method of obtaining peak values by Fourier transforming a spectrum of the reflected light may be suggested. However, for example, when a waveform of the spectrum is asymmetrical, it is difficult to obtain locations of peaks from the waveform of the spectrum via the Fourier transformation with high accuracy and to measure the optical path length with high accuracy.

Thus, in the present technology field, a temperature measuring apparatus capable of appropriately measuring a temperature of an object by using optical interference, a substrate processing apparatus, and a temperature measuring method are necessary.
(Patent Document 1) Japanese Laid-open Patent Publication No. 2006-220461

### SUMMARY OF THE INVENTION

According to an aspect of the present invention, there is provided a temperature measuring apparatus for measuring a temperature of an object having a first main surface and a second main surface which is opposite to the first main surface, the temperature measuring apparatus including: a data input unit which inputs a spectrum of interference light that is obtained when measuring light is irradiated to the first main surface of the object and the measuring light reflected by the first main surface and the measuring light reflected by the second main surface interfere with each other; a peak interval calculation unit which calculates a peak interval of the spectrum; an optical path length calculation unit which calculates a length of an optical path from the first main surface to the second main surface, based on the peak interval; and a temperature calculation unit which calculates the temperature of the object based on the optical path length.

In the temperature measuring apparatus, an optical path length from the first main surface to the second main surface may be calculated based on a peak interval of an interference light spectrum, and the temperature may be calculated based on the optical path length. That is, by calculating an optical path length from the first main surface to the second main surface based on the peak interval of the interference light spectrum, the optical path length may be acquired accurately without depending on a waveform of the spectrum. Accordingly, the temperature of the object may be measured appropriately.

The peak interval calculated by the peak interval calculation unit may be an interval between adjacent peaks. Then, the peak interval may be easily calculated, and the temperature of the object may be measured simply.

The peak interval calculation unit may calculate the optical path length based on an average value of a plurality of the peak intervals. The optical path length from the first main surface to the second main surface may be calculated accurately by calculating the optical path length based on the average of the plurality of peak intervals.

The temperature calculation unit may calculate the temperature of the object based on a correlation obtained in advance between temperatures of the object and the optical path length. The optical path length calculation unit may calculate the optical path length from the first main surface to the second main surface based on a correlation between peak intervals and optical path lengths. The object may be formed of silicon, quartz, or sapphire.

According to another aspect of the present invention, there is provided a substrate processing apparatus for performing a predetermined process on a substrate having a first main surface and a second main surface which is opposite to the first main surface and measuring a temperature of the substrate, the substrate processing apparatus including: a processing chamber which is configured to be vacuum exhausted and to accommodate the substrate; a light source which generates measuring light having a wavelength transmittable through the substrate; a spectroscope which measures spectrums depending on a wavelength or a frequency; an optical transfer mechanism which is connected to the light source and the spectroscope to emit the measuring light from the light source to the first main surface of the substrate and emit lights reflected from the first main surface and the second main surface to the spectroscope; a data input unit which inputs a spectrum of interference light obtained by interference between the lights reflected from the first main surface and the second main surface, wherein the spectrum is measured by the spectroscope; a peak interval calculation unit which calculates a peak interval in the spectrum; an optical path length calculation unit which calculates a length of an optical path from the first main surface to the second main surface, based on the peak interval; and a temperature calculation unit which calculates the temperature of the substrate based on the optical path length.

In the substrate processing apparatus, an optical path length from the first main surface to the second main surface may be calculated based on a peak interval of an interference light spectrum, and the temperature of the substrate that is object may be calculated based on the optical path length. That is, by calculating an optical path length from the first main surface to the second main surface based on the peak interval of the interference light spectrum, the optical path length may be acquired accurately without depending on a waveform of the spectrum. Accordingly, the temperature of the substrate, that is, the object may be measured appropriately.

According to another aspect of the present invention, there is provided a temperature measuring method for measuring a temperature of an object having a first main surface and a second main surface which is opposite to the first main surface, the temperature measuring method including: a data input process of inputting a spectrum of interference light that is obtained when measuring light is irradiated to the first main surface of the object and the measuring light reflected by the first main surface and the measuring light reflected by the second main surface interfere with each other; a peak interval calculation process of calculating a peak interval in the spectrum; an optical path length calculation process of calculating a length of an optical path from the first main surface to the second main surface based on the peak interval; and a temperature calculation process of calculating the temperature of the object based on the optical path length.

In the temperature measuring method, an optical path length from the first main surface to the second main surface may be calculated based on a peak interval of an interference light spectrum, and the temperature may be calculated based on the optical path length. That is, by calculating an optical path length from the first main surface to the second main surface based on the peak interval of the interference light spectrum, the optical path length may be acquired accurately without depending on a waveform of the spectrum. Accordingly, the temperature of the object may be measured appropriately.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a temperature measuring system including a temperature measuring apparatus according to an embodiment of the present invention;

FIG. 2 is a functional block diagram of a spectroscope and the temperature measuring apparatus;

FIG. 3 is a flowchart showing operations of the temperature measuring apparatus;

FIG. 4 is a view showing an example of a spectrum input to the temperature measuring apparatus;

FIG. 5 is a view showing an example of temperature correction data;

FIG. 6A is a view showing an example of an appropriate waveform of a spectrum, FIG. 6B is a view showing a waveform obtained by Fourier transformation of the spectrum of FIG. 6A, FIG. 5C is a view showing a waveform of a spectrum.

FIG. 6D is a view showing a waveform obtained by Fourier transformation of the spectrum of FIG. 6C, FIG. 6E is a view showing a waveform of a spectrum, and FIG. 5F is a view of a waveform obtained by Fourier transformation of the spectrum of FIG. 6E; and

FIG. 7 is a view showing a substrate processing apparatus according to an embodiment of the present invention.

### DETAILED DESCRIPTION OF THE INVENTION

Hereinafter, the present invention will be described in detail by explaining exemplary embodiments of the invention with reference to the attached drawings. Like reference numerals in the drawings denote like elements.

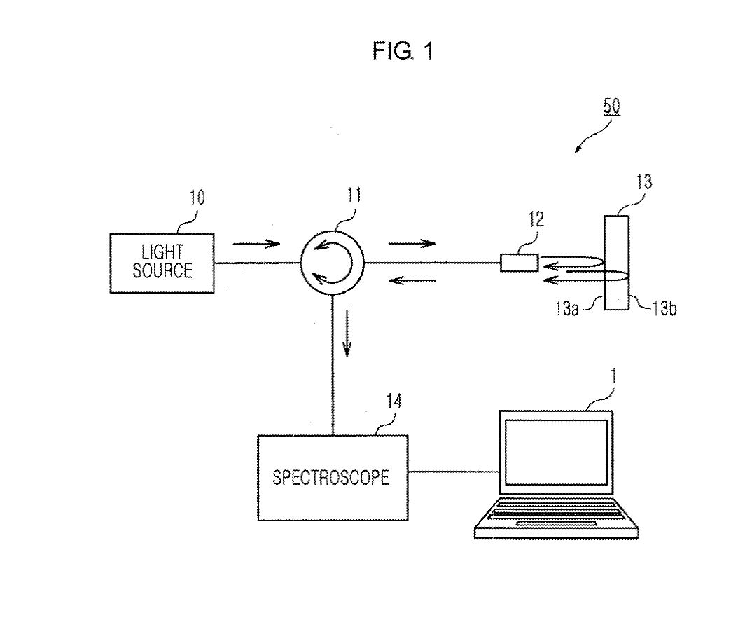

FIG. 1 is a block diagram of a temperature measuring system 50 including a temperature measuring apparatus 1 according to an embodiment of the present invention. As shown in FIG. 1, the temperature measuring system 50 is a system for measuring a temperature of an object 13. The temperature measuring system 50 measures the temperature of the object 13 by using optical interference. The temperature measuring system 50 includes a light source 10, an optical circulator 11, a collimator 12, a spectroscope 14, and the temperature measuring apparatus 1. Connections to each of the light source 10, the optical circulator 11, the collimator 12, and the spectroscope 14 may be performed by using, for example, optical fiber cables.

The light source 10 generates measuring light having a wavelength transmittable through the object 13. An amplified spontaneous emission (ASE) light source, for example, may be used as the light source 10. The object 13 may be formed as, for example, a plate shape, and includes a first main surface 13a and a second main surface 13b which is opposite to the first main surface 13a. Hereinafter, if necessary, the first main surface 13a will be referred to as a surface 13a, and the second main surface 13b will be referred to as a rear surface 13b. The object 13 may be, for example, SiO (quartz) or Al₂O₃ (sapphire), in addition to Si (silicon). A refractive index of Si is 3.4 when a wavelength is 4 μm. A refractive index of SiO₂ is 1.5 when a wavelength is 1 μm. A refractive index of Al₂O₃ is 1.8 when a wavelength is 1 μm.

The optical circulator 11 is connected to the light source 10, the collimator 12, and the spectroscope 14. The optical circulator 11 emits the measuring light generated by the light source 10 to the collimator 12. The collimator 12 emits the measuring light to the surface 13a of the object 13. The collimator 12 emits the measuring light that is adjusted as parallel light to the object 13. In addition, light reflected from the object 13 is incident on the collimator 12. The reflected light may include light reflected from the rear surface 13b and light reflected from the surface 13a. The light reflected from the surface 13a and the light reflected from the rear surface 13b interfere with each other, thereby generating interference light. The collimator 12 emits the reflected light to the spectroscope 14. A light transferring mechanism is configured by using the optical circulator 11 and the collimator 12.

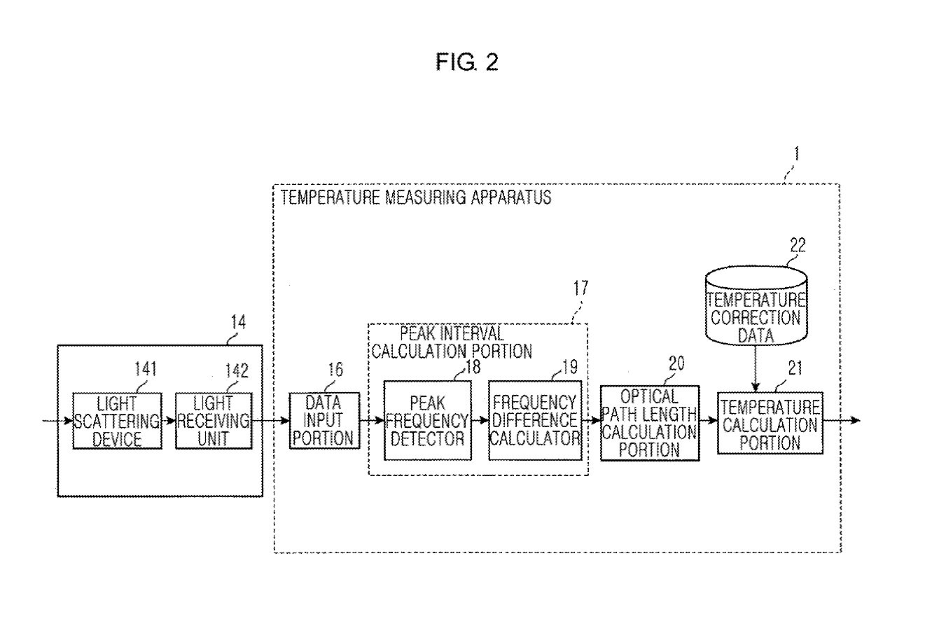

The spectroscope 14 measures a spectrum of the interference light obtained from the optical circulator 11. The interference light spectrum represents an intensity distribution according to wavelengths or frequencies of the interference light. FIG. 2 is a functional block diagram of the spectroscope 14 and the temperature measuring apparatus 1. As shown in FIG. 2, the spectroscope 14 includes, for example, a light-scattering device 141 and a light receiving unit 142. The light-scattering device 141 is, for example, a diffraction grating, and is a device for dispersing the light with a predetermined dispersion angle at every wavelength. The light receiving unit 142 acquires the light dispersed by the light-scattering device 141. A charge coupled device (COD) in which a plurality of light receiving devices are arranged in a gratings shape is used as the light receiving unit 142. The number of light receiving devices is the number of samplings. In addition, wavelength span of the dispersion angle of the light-scattering device 141 and wavelength span of the light-scattering device 141 are regulated based on a distance to the light receiving devices. Accordingly, the interference light is dispersed at every wavelength or every frequency, and a spectrum is obtained at every wavelength or every frequency. The spectroscope 14 outputs the interference light spectrum to the temperature measuring apparatus 1.

The temperature measuring apparatus 1 measures a temperature of the object 13 based on the interference light spectrum. The temperature measuring apparatus 1 includes a data input portion (data input unit) 16, a peak interval calculation portion (peak interval calculation unit) 17, an optical path length calculation portion (optical path length calculation unit) 20, a temperature calculation portion (temperature calculation unit) 21, and temperature correction data 22. The peak interval calculation portion 17 includes a peak frequency detector 18 and a frequency difference calculator 19. The optical path calculation portion 20 calculates an optical path length based on a peak interval.

The temperature calculation portion 21 calculates the temperature of the object 13 based on the optical path length. The temperature calculation portion 21 calculates the temperature of the object 13 by referencing the temperature correction data 22. The temperature correction data 22 is data that is measured in advance and represents correlations between temperatures and optical path lengths.

According to the temperature measuring system 50 having the above configuration, the temperature of the object 13 is measured by using optical interference between the surface 13a and the rear surface 13b of the object (frequency region optical coherence tomography). Hereinafter, a method of obtaining the optical path length based on the peak interval of the interference light spectrum will be described. When the measuring light emitted from the light source 10 is used as incident light, a spectrum S(λ) of the incident light is dependent upon a wavelength λ. A thickness of the object 13 is d, a refractive index of the object 13 is n, and a reflectivity of the object 13 is R. A spectrum I(λ) of the reflected light and the spectrum S(λ) of the incident light have relation as the following Equation (1).

$${I}_{D} ( λ ) = R \{ 1 + {( 1 - R )}^{2} + 2 ( 1 - R ) cos ( 2 n \times \frac{2 π}{λ} \times d ) \} S ( λ ) \qquad ( 1 )$$

When the wavelength λ is written in terms of v, the above Equation (1) may be represented by the following Equation (2).

$${I}_{D} ( v ) = R \{ 1 + {( 1 - R )}^{2} + 2 ( 1 - R ) cos ( 2 n \times 2 π \frac{v}{c} \times d ) \} S ( v ) \qquad ( 2 )$$

In the above equation (2), when a variable of a cosine function is an integer multiple of 2π, the interference light has a peak. Therefore, frequencies of peaks may be represented by the following Equation (3).

$${v}_{1} = \frac{{m}_{1} c}{2 nd} , {v}_{2} = \frac{{m}_{2} c}{2 nd} , {v}_{3} = \frac{{m}_{3} c}{2 nd} , … {v}_{N} = \frac{{m}_{N} c}{2 nd} \qquad ( 3 )$$

Here, v₁, v₂, v₃, . . . , v_{N} denote frequencies of the peaks. In addition, m_{N} denotes an integer of 1 or greater. That is, for example, when m₁ is 1, m₂ is 2 and m₃ is 3. In addition, c denotes a luminous flux of the interference light. A frequency difference is represented as, for example, v₂−v₁, v₃−v₂, . . . , v_{N}−v_{N-1}. That is, the frequency difference may be represented by the following Equation (4). In addition, N is an integer of 2 or greater.

$${v}_{2} - {v}_{1} = {v}_{3} - {v}_{2} = … = {v}_{N} - {v}_{N - 1} = \frac{c}{2 nd} \qquad ( 4 )$$

Therefore, when converting the Equation (4), an optical length path nd may be represented by the following Equation (5).

$$nd = \frac{c}{2 ( {v}_{2} - {v}_{1} )} = \frac{c}{2 ( {v}_{3} - {v}_{2} )} = \frac{c}{2 ( {v}_{4} - {v}_{3} )} = … = \frac{c}{2 ( {v}_{N} - {v}_{N - 1} )} = 〈 \frac{c}{2 ( {v}_{i} - {v}_{i - 1} )} 〉 \qquad ( 5 )$$

A correlation between the peak interval and the optical path length nd is represented by the above Equation (5). In addition, in a general expression shown at a right side of the above Equation (5), i denotes an integer of 2 or greater.

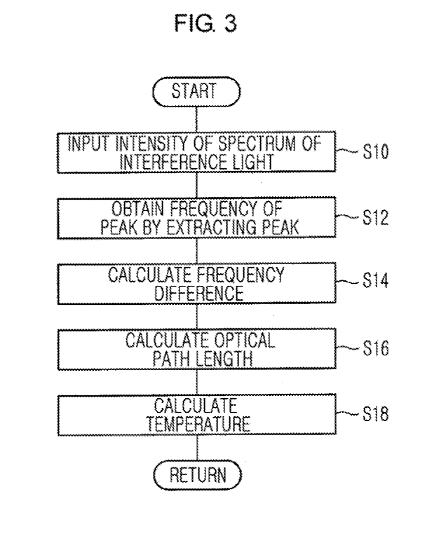

Next, temperature measuring operations of the temperature measuring system 50 including the temperature measuring apparatus 1 will be described as follows. FIG. 3 is a flowchart showing operations of the temperature measuring system 50. Controlling process shown in FIG. 3 is repeatedly performed at a predetermined interval from a timing when, for example, the light source 10 and the temperature measuring apparatus 1 are turned on.

As shown in FIG. 3, the process is started by inputting the interference light spectrum (S10: data input process). The light source 10 generates the measuring light. The spectroscope 14 acquires a spectrum of the interference light generated when the light reflected from the surface 13a of the object 13 and the light reflected from the rear surface 13b of the object 13 interfere with each other. The spectrum of the interference light is input to the data input portion 16 from the spectroscope 14. When the process of S10 ends, the process goes to a peak extraction process (S12).

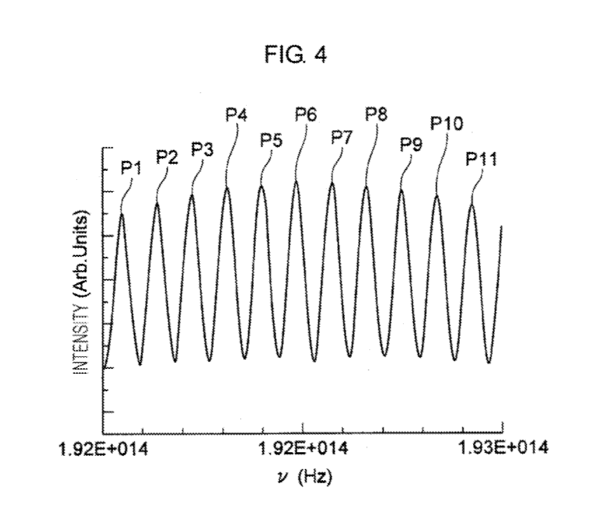

In the process S12, the peak frequency detector 18 extracts the peaks from a waveform of the spectrum obtained in the operation S10, and acquires frequencies corresponding to the extracted peaks. For example, as shown in FIG. 4, there are a plurality of peaks in a waveform of an interference light spectrum. In FIG. 4, a transverse axis denotes a frequency of the interference light, and a longitudinal axis denotes an intensity of the interference light. In the spectrum of the interference light shown in FIG. 4, eleven peaks P1 through P11 are shown within a frequency band of 1.92×10¹⁴ to 1.93×10¹⁴ Hz. In the operation of S12, the frequencies of the peaks are extracted from an entire spectral wavelength region of the spectroscope 14. For example, an approximation of the spectrum waveform of the interference light shown in FIG. 4 is obtained by using the above equation (2), and the frequencies of the peaks are extracted by differentiating the approximation. In the present embodiment, a plurality of frequencies of the peaks are extracted. When the operation of S12 ends, the process goes to a frequency difference calculation (S14). In addition, the operation S12 and the operation S14 are a peak interval calculation process.

In the operation S14, the frequency difference calculation portion 19 calculates an interval between neighboring peaks (vᵢ−vᵢ₋₁) based on the frequencies of the plurality of peaks, which are obtained in the operation S12. The peak interval may be defined as a difference between the frequencies corresponding to the peaks. That is, the peak interval is a difference between the frequencies corresponding to intensities of the peaks. In the operation S12, in a case where frequencies of three or more peaks are extracted, the frequency difference calculation portion 19 calculates intervals between the peaks, and calculates an average of the calculated intervals between the peaks. When the operation S14 ends, the process goes to an optical path length calculation process (S16: optical path length calculation process).

In the operation S16, the optical path length calculation unit 20 calculates the optical path length nd based on the peak intervals obtained in the operation S14. The optical path length nd is calculated by using the frequency difference and the above equation (5). When the operation S16 ends, the process goes to a temperature calculation process (S18).

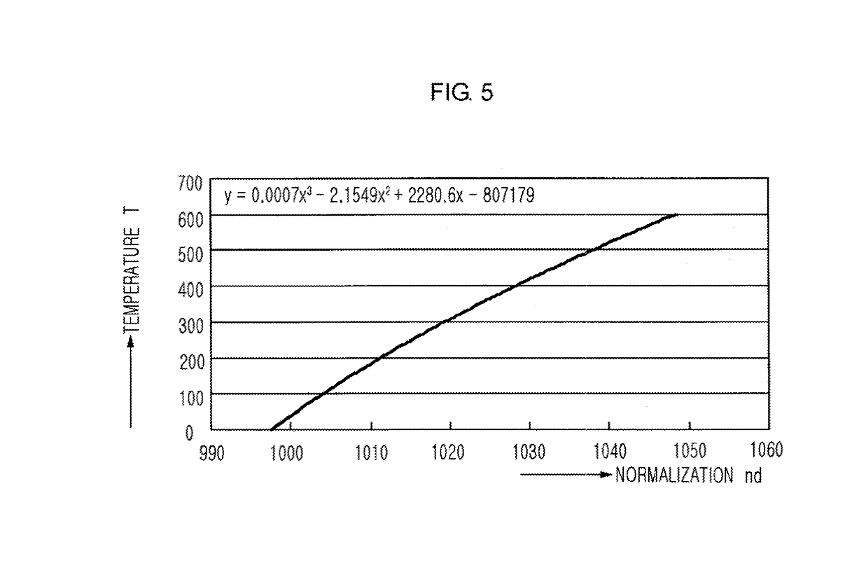

In the operation S18, the temperature calculation portion 21 calculates the temperature by using the optical path length nd obtained in the operation S16 (temperature calculation process). The temperature of the object 13 and the optical path length nd has a correlation, for example, as shown in FIG. 5. The temperature calculation portion 21 calculates the temperature by using, for example, the temperature correction data 22 shown in FIG. 5. In FIG. 5, a transverse axis denotes the optical path length nd, and a longitudinal axis denotes the temperature. The temperature correction data 22 is obtained with respect to the object 13 in advance. Hereinafter, an example of generating the temperature correction data 22 in advance will be described. For example, temperatures are actually measured by using a blackbody furnace. Temperatures T and optical path lengths nd_{T} corresponding to the temperatures T are simultaneously measured. The temperatures T are measured by using a thermometer such as a thermocouple. In addition, the optical path lengths nd_{T} are measured by using the above described method of using the peak intervals of the spectrum. In addition, the temperature and the normalized optical path length nd_{T} are approximated at every 100° C. according to a cubic equation to derive a coefficient of an approximate curve. Equation shown on upper left portion of FIG. 5 is the cubic equation. In addition, a function of the normalized optical path length nd_{T} depending upon the temperature T is expressed by the following equation (6).

$$f ( T ) = \frac{n \cdot {d}_{T}}{n \cdot {d}_{40}} \qquad ( 6 )$$

In addition, a reversed function of f(T) is represented by the following equation (7).

$$T = {f}^{- 1} ( \frac{n \cdot {d}_{T}}{n \cdot {d}_{40}} ) \qquad ( 7 )$$

The optical path length nd₄₀ is calculated by the following equation (8) according to both an initial temperature Tₒ and an optical path length nd_{T0} at that time.

$$n \cdot {d}_{40} = \frac{n \cdot {d}_{T 0}}{f ( T 0 )} \qquad ( 8 )$$

Based on the optical path length nd₄₀ obtained based on the above equation (5) and the optical path length nd_{T}, the temperature T is calculated by using the above equation (8). When the operation S18 ends, the controlling processes shown in FIG. 3 are finished.

According to the temperature measuring system 50 and the temperature measuring method of the present embodiment, the optical path length nd from the surface 13a to the rear surface 13b is calculated based on the peak intervals in the spectrum of the interference light, and the temperature of the object 13 is calculated based on the optical path length nd. That is, by calculating the optical path length nd from the surface 13a to the rear surface 13b based on the peak intervals in the spectrum of the interference light, the optical path length nd may be obtained with high accuracy without depending on the waveform of the spectrum. Accordingly, the temperature of the object 13 can be measured appropriately.

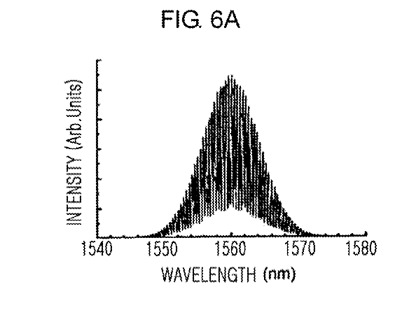

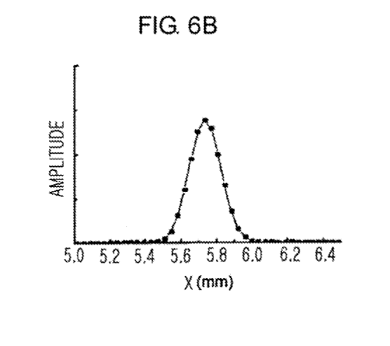

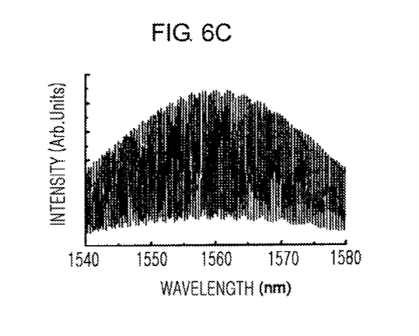

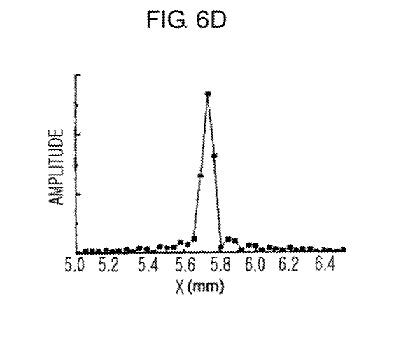

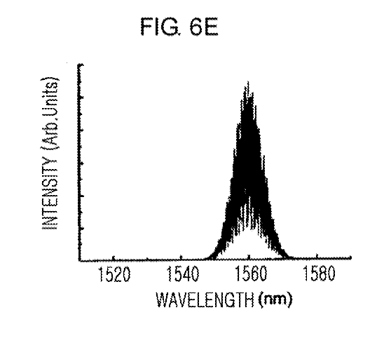

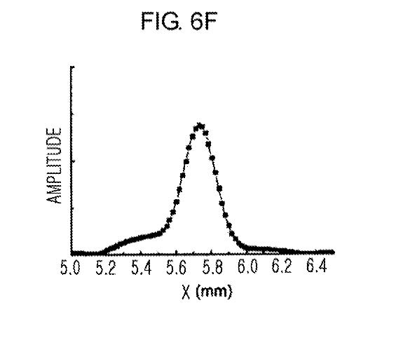

Hereinafter, a case where peak locations are obtained by performing a Fourier transformation of a spectrum will be described to be compared with the temperature measuring system 50 according to the present embodiment. FIG. 6A shows an example of a spectrum waveform. The waveform of the spectrum shown in FIG. 6A is a waveform of a case where the spectral wavelength region of the spectroscope 14 is set to be sufficiently wider than a wavelength region of the light emitted from the light source 10, and a center frequency of the spectral wavelength of the spectroscope 14 and a center frequency of the wavelength of the light emitted from the light source 10 coincide with each other. When the waveform of the spectrum shown in FIG. 6A is Fourier transformed, a waveform shown in FIG. 6B is obtained. A location of a peak representing an optical path length can be obtained with high accuracy from the waveform shown in FIG. 6B.

Meanwhile, FIG. 6C shows another example of a waveform of a spectrum. The waveform of the spectrum shown in FIG. 6C is a waveform in a case where the spectral wavelength region of the spectroscope 14 is set to be narrower than the wavelength region of the light emitted from the light source 10, and the center frequency of the spectral wavelength of the spectroscope 14 and the center frequency of the wavelength of the light emitted from the light source 10 coincide with each other. When the waveform of the spectrum shown in FIG. 6C is Fourier transformed, a waveform shown in FIG. 6D is obtained. As shown in FIG. 6D, since a peak rises sharply, it is difficult to calculate a location of the peak representing an optical path length with high accuracy.

In addition, FIG. 6E shows another example of a waveform of a spectrum. The waveform of the spectrum shown in FIG. 6E is a waveform in a case where the spectral wavelength region of the spectroscope 14 is set to be sufficiently wider than the wavelength region of the light emitted from the light source 10; however, the center frequency of the spectral wavelength of the spectroscope 14 and the center frequency of the wavelength of the light emitted from the light source 10 does not coincide with each other. Wen the waveform of the spectrum shown in FIG. 6E is Fourier transformed, a waveform shown in FIG. 6F is obtained. As shown in FIG. 6F, since the waveform is messy, it is difficult to obtain a location of a peak representing an optical path length with high accuracy.

As described above, in order to calculate peaks representing optical path lengths with high accuracy by using the Fourier transformation, it is necessary to set the spectral wavelength region of the spectroscope 14 to be wider than the wavelength region of the light emitted from the light source 10 and to coincide the center frequency of the spectral wavelength of the spectroscope 14 with the center frequency of the wavelength of the light emitted from the light source 10.

However, according to the temperature measuring apparatus 1 and the temperature measuring method of the present embodiment, the optical path length nd from the surface 13a to the rear surface 13b is calculated based on the peak intervals in the spectrum of the interference light, and accordingly, the optical path length nd can be calculated precisely without depending on the waveform of the spectrum. Therefore, the optical path length nd can be obtained precisely without strictly setting a relation between the wavelength region of the light emitted from the light source 10 and the spectral wavelength region of the spectroscope 14.

In addition, the above described embodiment is an example of the temperature measuring apparatus 1 and the temperature measuring method, and the apparatus or the method may be modified or applied according to embodiments.

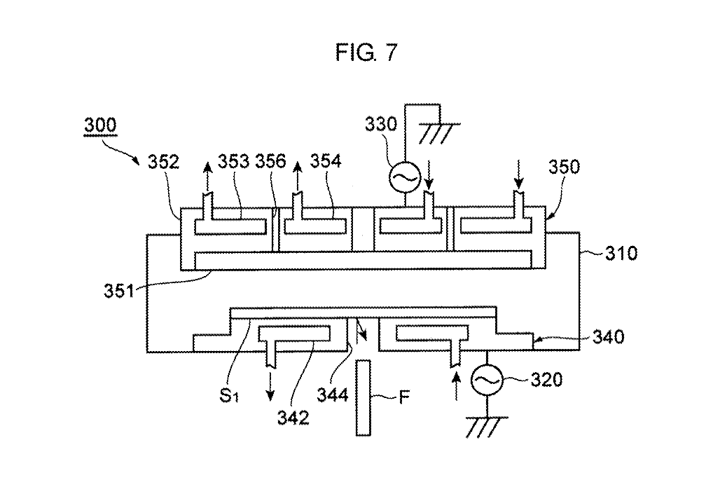

For example, the temperature measuring apparatus 1 may be mounted in a substrate processing apparatus, FIG. 7 shows an example of the substrate processing apparatus. Herein, for example, a case of applying the temperature measuring apparatus 1 to measure a temperature of a wafer (substrate) Tw as, an example of the object 13, in the substrate processing apparatus, for example, a plasma etching apparatus, will be described.

The light source 10 for generating the measuring light may irradiate light that may be transmitted through and reflected by opposite end surfaces S1 and S2 of the wafer Tw, that is, the object 13. For example, since the wafer Tw is formed of silicon, the light source 10 may irradiate light having a wavelength of about 1.0 to 2.5 μm, which can transmit through a silicon material such as silicon, a silicon oxide film, and the like.

As shown in FIG. 7, a substrate processing apparatus 300 includes a processing chamber 310, in which a predetermined process such as an etching process or a film forming process is performed on the wafer Tw, for example. That is, the wafer Tw is accommodated in the processing chamber 310. The processing chamber 310 is connected to an exhaust pump (not shown) to be vacuum exhausted. In the processing chamber 310, an upper electrode 350 and a lower electrode 340 facing the upper electrode 350 are provided. The lower electrode 340 also functions as a holding stage on which the wafer Tw is placed. An electrostatic chuck (not shown) for electrostatically adsorbing, for example, the wafer Tw is provided on an upper portion of the lower electrode 340. In addition, a cooling unit is provided in the lower electrode 340. The cooling unit controls, for example, a temperature of the lower electrode 340. Accordingly, a temperature of the wafer Tw is controlled. The wafer Tw is carried into the processing chamber 310 from, for example, a gate valve (not shown) provided on a side surface of the processing chamber 310. Radio frequency power sources 320 and 330 applying predetermined radio frequency power are respectively connected to the lower electrode 340 and the upper electrode 350.

The upper electrode 350 is configured to support an electrode plate 351 that is located at a lowermost portion by using an electrode supporter 352. The electrode plate 351 is formed of, for example, a silicon material (silicon, silicon oxide, and the like), and the electrode supporter 352 is formed of, for example, aluminum material. An inlet tube (not shown) through which a predetermined processing gas is introduced is provided on an upper portion of the upper electrode 350. A plurality of ejection holes (not shown) are formed in the electrode plate 351 so that the processing gas introduced from the inlet tube can be evenly ejected toward the wafer Tw placed on the lower electrode 340.

A cooling unit is provided in the upper electrode 350. The cooling unit controls a temperature of the upper electrode 350, for example, by circulating a coolant in a coolant passage formed in the electrode supporter 352 of the upper electrode 350. The coolant passage is roughly loop shaped, and is divided into two systems, for example, an outer coolant passage 353 for cooling an outer side of a surface of the upper electrode 350, and an inner coolant passage 354 for cooling an inner side of the surface of the upper electrode 350. Each of the outer coolant passage 353 and the inner coolant passage 354 is configured so that the coolant is circulated, that is, supplied from a supply tube, circulated in each of the coolant passages 353 and 354, and is discharged from a discharge tube and returned to an external freezer (not shown), as denoted by an arrow of FIG. 7. The same coolant may be circulated in the two systems of coolant passages. In addition, the present invention is not limited to the two coolant passage systems shown in FIG. 7, for example, only one coolant passage system may be provided or one coolant passage system dividing into two branches may be provided.

In the electrode supporter 352, a low heat transfer layer 356 is formed between an outer portion of the electrode supporter 352 in which the outer coolant passage 353 is formed and an inner portion of the electrode supporter 352 in which the inner coolant passage 354 is formed. Accordingly, it is difficult to transfer heat between the outer portion and the inner portion of the electrode supporter 352 due to the low heat transfer layer 356, and thus it is possible to control temperatures of the outer portion and the inner portion to be different from each other by controlling the coolant in the outer coolant passage 353 and the inner coolant passage 354. As such, an in-plane temperature of the upper electrode 350 can be efficiently and precisely controlled.

In the substrate processing apparatus 300, the wafer Tw is carried into the processing chamber 310 through a gate valve by, for example, a transfer arm or the like. The wafer Tw carried into the processing chamber 310 is placed on the lower electrode 340, radio frequency power is applied to the upper electrode 350 and the lower electrode 340, and a predetermined processing gas is introduced in the processing chamber 310 from the upper electrode 350. Accordingly, the processing gas introduced from the upper electrode 350 is plasmatized, and an etching process, for example, is performed on a surface of the wafer Tw.

The measuring light of the temperature measuring apparatus 1 is configured to be transmitted to a measuring light irradiation position on which the measuring light is irradiated onto the wafer Tw, that is, the object, from the lower electrode 340, via optical fibers F formed in the collimator 12. In more detail, the optical fiber F is provided so that the measuring light can be irradiated toward the wafer Tw via a penetration hole 344 formed in the lower electrode 340, for example, a center portion of the lower electrode 340. A location in-plane direction of the wafer Tw, where the optical fiber F is provided, may not be the center portion of the wafer Tw shown in FIG. 7, so long as the measuring light is irradiated onto the wafer Tw. For example, the optical fiber F may be provided so that the measuring light is irradiated to an end portion of the wafer Tw.

As described above, by mounting the temperature measuring system 50 including the temperature measuring apparatus 1 in the substrate processing apparatus 300, the temperature of the wafer Tw constituting the object, during the etching process can be measured. In addition, the above described initial temperature Tₒ is measured when the wafer Tw is electrostatically adsorbed on the lower electrode 340 and a pressure of the predetermined processing gas is stabilized. For example, a thermocouple is mounted on the lower electrode 340, and the temperature of the lower electrode 340 is set as the temperature of the wafer Tw and the optical path length nd at this time may be set as an initial length. In addition, a contact type thermometer may be formed on the lower electrode 340 to measure the temperature when transferring the wafer Tw. Also, an example of measuring the temperature of the wafer Tw is described herein; however, if parts such as the upper electrode 350 or a focus ring in the chamber are formed of a material that may transmit the measuring light, a temperature of the corresponding part in the chamber 310 may be measured. In this case, the parts of the chamber 310 may be formed of silicon, quartz, sapphire, or the like.

In addition, in the above embodiment, the optical circulator 11 is provided; however, 2×1 or 2×2 photo couplers may be provided. When using the 2×2 photo couplers, a reference mirror may not be provided.

Also, in the above embodiment, an example of forming the spectroscope 14 is described. In the above embodiment, the optical path length nd is calculated based on the peak interval in the spectrum of the interference light. Therefore, an optical transfer apparatus, for example, a wavelength division multiple (WDM) monitor, for outputting peak values and peak frequencies may be used instead of the spectroscope 14. In addition, in the above embodiment, the peak interval is defined as a difference between a frequency corresponding to a first peak and a frequency corresponding to a peak adjacent to the first peak. However, the peak interval is not limited thereto. For example, in the spectrum shown in FIG. 4, even-numbered peaks P2, P4, P6, P8, and P10 may be extracted to calculate intervals therebetween. That is, the peak interval can be represented as v₂ᵢ−v₂₍ᵢ₋₁₎ (i is an integer of 2 or greater). Otherwise, odd-numbered peaks P1, P3, P5, P7, P9, and P11 may be extracted to calculate intervals therebetween. That is, the peak interval can be represented as v₂ᵢ₋₁−v₍₂₍ᵢ₋₁₎₋₁₎ (i is an integer of 2 or greater).

As described above, according to embodiments of the present invention, the temperature measuring apparatus capable of appropriately measuring a temperature of a object by using optical interference, the substrate processing apparatus, and the temperature measuring method are provided.

While this invention has been particularly shown and described with reference to exemplary embodiments thereof, it will be understood by those skilled in the art that various changes in form and details may be made therein without departing from the spirit and scope of the invention as defined by the appended claims.

1. A temperature measuring apparatus for measuring a temperature of an object having a first main surface and a second main surface which is opposite to the first main surface, the temperature measuring apparatus comprising:
a data input unit which inputs a spectrum of interference light that is obtained when measuring light is irradiated to the first main surface of the object and the measuring light reflected by the first main surface and the measuring light reflected by the second main surface interfere with each other;
a peak interval calculation unit which calculates a peak interval of the spectrum;
an optical path length calculation unit which calculates a length of an optical path from the first main surface to the second main surface, based on the peak interval; and
a temperature calculation unit which calculates the temperature of the object based on the optical path length.

2. The temperature measuring apparatus of claim 1, wherein the peak interval calculated by the peak interval calculation unit is an interval between adjacent peaks.

3. The temperature measuring apparatus of claim 1, wherein the peak interval calculation unit calculates the optical path length based on an average value of a plurality of the peak intervals.

4. The temperature measuring apparatus of claim 1, wherein the temperature calculation unit calculates the temperature of the object based on a correlation obtained in advance between temperatures of the object and the optical path length.

5. The temperature measuring apparatus of claim 1, wherein the optical path length calculation unit calculates the optical path length from the first main surface to the second main surface based on a correlation between peak intervals and optical path lengths.

6. The temperature measuring apparatus of claim 1, wherein the object is formed of silicon, quartz, or sapphire.

7. A substrate processing apparatus for performing a predetermined process on a substrate having a first main surface and a second main surface which is opposite to the first main surface and measuring a temperature of the substrate, the substrate processing apparatus comprising:
a processing chamber which is configured to be vacuum exhausted and to accommodate the substrate;
a light source which generates measuring light having a wavelength transmittable through the substrate;
a spectroscope which measures spectrums depending on a wavelength or a frequency;
an optical transfer mechanism which is connected to the light source and the spectroscope to emit the measuring light from the light source to the first main surface of the substrate and emit lights reflected from the first main surface and the second main surface to the spectroscope;
a data input unit which inputs a spectrum of interference light obtained by interference between the lights reflected from the first main surface and the second main surface, wherein the spectrum is measured by the spectroscope;
a peak interval calculation unit which calculates a peak interval in the spectrum;
an optical path length calculation unit which calculates a length of an optical path from the first main surface to the second main surface, based on the peak interval; and
a temperature calculation unit which calculates the temperature of the substrate based on the optical path length.

8. (canceled)
